(19) United States
(12) Patent Application Publication
(10) Pub. No.: US 2026/0273536 A1
(43) Pub. Date: Sep. 17, 2026

(54) CONDUCTIVE MEDICAL COMPONENTS

(71) Applicant: Ritter GmbH, Schwabmuenchen (DE)

(72) Inventor: Frank FINIS, Augsburg (DE)

(21) Appl. No.: 19/555,085

(22) Filed: Mar. 3, 2026

(30) Foreign Application Priority Data
Mar. 17, 2025 (DE) 10 2025 110 261.9

(51) Int. Cl. B01L 9/00

(52) U.S. Cl. CPC B01L 9/543; B01L 2300/0809; B01L 2300/12

(57) ABSTRACT

A device 1 according to the invention for holding pipette tips 2 has a tray 10 comprising a holding area 100 and openings or cutouts 101 formed in the holding area 100. Furthermore, the device 1 has a carrier 11 comprising four legs 110 extending downward from the tray 10. A standing surface 111 is formed on the underside of each of the legs 110. The device 1 (i.e., tray 10 and carrier 11) is made of electrically conductive plastic in order to establish an electrical connection between the pipette tips 2 and the standing surface 111 of the device 1.

### TECHNICAL FIELD

The application relates to devices for holding pipette tips, comprising at least one tray having at least one placement area or holding area with a plurality of openings for inserting the pipette tips.

### PRIOR ART

Manual and automatic pipetting devices or pipetting machines for handling pipette tips are used in a variety of analytical applications in which liquids are handled, for example transported, picked up or dispensed, for example in laboratories. Disposable pipette tips are used in these devices or machines. Disposable pipette tips are usually conical in shape from top to bottom and may have specially shaped sections for gripping and sealing the pipette tips against a coupling device of the device or machine that engages with the interior of the pipette tip. Pipetting devices or automated pipetting machines usually grip the top of the pipette tip. In many applications, the coupling device is inserted into the upper interior volume of the pipette tip. Pipettes or automated pipetting devices exert negative pressure to draw liquids into the pipette tip and generate positive pressure to dispense liquids.

Pipette tips are usually made from moldable plastic, such as polypropylene, e.g., polypropylene homopolymer (PP-H), polyethylene, or similar, using an injection molding process, as plastics offer a good combination of properties such as chemical resistance, low surface adsorption, transparency (if required), and cost-efficient production. Pipette tips are also manufactured in various sizes in order to enable accurate and reproducible handling of liquids in a wide volume range (nanoliters to milliliters).

In many cases, pipette tips are used in large quantities for the automated processing of a large number of samples and for adding various reagents to samples.

However, there are special applications in which pipette tips made of materials such as ceramic or metal are used, for example, in cases of high chemical requirements, necessary corrosion resistance or temperature resistance, etc. In addition, ceramic pipette tips with smaller dimensions, in particular smaller outlet openings, may be manufactured. However, ceramic or metal pipette tips are much more complex in terms of manufacturing and material use.

In order to enable easy handling of large quantities, pipette tips are often supplied in a pipette tip tray with openings on the top in which the pipette tips are arranged and held in an array. The tray may in turn be arranged or mounted on a carrier. The tray and the carrier form a pipette tip holder, which may be equipped with a lid that covers the pipette tips.

Incidentally, pipette tip holders are designed in such a way that a large number of samples may be analyzed in parallel in analytical laboratories, with each holder being used for specific process steps.

However, the use of plastic pipette tips may prove problematic if the pipette tips become electrostatically charged during handling. Static charging of the pipette tips and other components of the holder may cause the tips to repel each other, which may result in the tips being aligned differently than intended in the tray. As a result, interaction with pipetting devices or automated pipetting systems may be adversely affected, leading to inaccurate handling and thus to erroneous analyses. Electrostatic charge may be transferred in an undesirable manner to a user of a pipetting device. In addition, highly sensitive measuring instruments may be impaired by static charge.

Furthermore, static charge may prevent the pipette tips from being effectively detached from the pipetting device.

### OBJECT OF THE INVENTION

Based on this, it is an object of the present invention to provide medical components that enable convenient and reliable handling of pipette tips.

### SUMMARY OF THE INVENTION

This object is attained by a device for holding pipette tips according to claim 1. Features of the dependent claims relate to preferred embodiments of the invention.

A device for holding pipette tips according to the invention comprises: at least one tray (placement part) having at least one placement area or holding area with a plurality of openings for inserting the pipette tips, wherein the tray comprises electrically conductive material for dissipating electrostatic charge from the pipette tips.

The tray may be made entirely or partially of electrically conductive material, or may only have electrically conductive material in certain areas or may have conductor tracks/lines made of electrically conductive material. It is crucial that an electrically conductive connection is established between the pipette tips inserted into the openings of the tray and a support or base on which the device stands (standing surface), via which electrostatic charge may be dissipated from the pipette tips to the base, thereby providing a kind of grounding of the pipette tips.

The conductor track may be, for example, a (possibly flat, thin) coating, an injection-molded track, an element incorporated into the device, e.g., a wire, or similar. An injection-molded track may be produced, for example, in a 2K (2-component) injection molding process.

In particular, the device comprises a carrier (rack) for carrying the tray, wherein the carrier has a frame with a window arranged in the upper area of the frame for inserting the tray, and a base surface (standing surface) arranged in the lower area of the frame.

The tray and the carrier may be formed as a single piece or as multiple pieces. In particular, the device comprises a carrier (rack) for carrying the tray, wherein the carrier and the tray are formed as a single piece to form a combined carrier/tray component, which has a standing surface arranged in the lower region of the component.

The carrier may comprise electrically conductive material for dissipating electrostatic charge from the tray to the standing surface.

The tray and/or the carrier or the combined carrier/tray component may be made of electrically conductive material.

The tray and/or the carrier or the combined carrier/tray component may comprise conductive plastic/resin.

The tray and/or the carrier or the combined carrier/tray component may comprise at least one conductor track which is designed to establish an electrical connection between the openings of the tray and the surface of the base.

The at least one conductor track may be made of electrically conductive material.

The conductor track may be made of electrically conductive plastic/resin. However, alternatively, metal (e.g., in the form of a coating, wire, or foil) may be used as the conductive material.

In particular, the conductor track may have contact areas and/or connection areas. The contact areas are arranged in particular in the area of the openings of the tray.

The electrically conductive material may be integrated in the material of the tray and/or the carrier or in the combined carrier/tray component and/or arranged as a coating on the tray and/or on the rack or on the combined rack/tray component.

### BRIEF DESCRIPTION OF THE FIGURES

Further features and advantages of the invention will become apparent from the following description with reference to the figures. The figures show:

FIG. 1 a perspective view of a first embodiment of a device for holding pipette tips according to the present invention;

FIG. 2 a side view of the first embodiment;

FIG. 3 a perspective sectional view of a second embodiment of a device for holding pipette tips according to the present invention;

FIG. 4 a side sectional view of the second embodiment;

FIG. 5 a perspective view of a third embodiment of a device for holding pipette tips according to the present invention;

FIG. 6 a side view of the third embodiment;

FIG. 7 a perspective view of a carrier of the third embodiment;

FIG. 8 a perspective view of a tray of the third embodiment.

### DESCRIPTION OF PREFERRED EMBODIMENTS OF THE INVENTION

The invention generally relates to the provision of medical components that may be used to solve problems due to electrostatic charge that may arise during and as a result of the handling of pipette tips.

### Pipette Tip Holders

A pipette tip holder or tray is an arrangement of components that provides pipette tips for use by a user. Pipette tip holders often feature at least one carrier (“rack”), a lid, and a tray in which the pipette tips are held, with the pipette tips arranged in an array in a substantially immovable manner.

The tray is arranged on the top of the carrier and has openings for receiving and holding pipette tips. The tray may be formed integrally with the carrier, e.g., molded onto it, or the tray may form a separate unit or component that is attached to the carrier, e.g., by a snap or latch connection, by gluing, welding, etc.

The pipette tips used are inserted removably into the openings of the tray. The tray has an upper surface facing upwards, and a lower surface facing downwards. The pipette tips usually rest on the edge of one of the openings of the tray. The pipette tips received in the openings may protrude upward beyond the edge and the upper surface of the tray, while the lower portion of the pipette tips is usually located below the lower surface of the tray. The tray may have a suitable number of openings, e.g., 8×n (n=1, 2, . . . , 432) openings.

Each component of the pipette tip holder may be made of a suitable material, e.g., one or more plastic materials, e.g., polypropylene (PP), polyethylene (PE), polyethylene terephthalate (PET), polycarbonates, polyvinyl chloride (PVC), polyethylene fluoroethylene (PEFE), polystyrene (PS), polysiloxanes, polyurethane, cellulose, polyamide (PA), etc.

The components of the pipette tip holder or tray may be molded individually and then assembled. Manufacturing processes for the components include, for example, thermoforming, extrusion, or casting (such as plastic injection molding).

The components of the pipette tip holder are assembled or joined together, or they may be manufactured using a 2-component injection molding process. The cover may be placed precisely on the carrier, e.g., engaging in a groove or recess formed in the carrier. The cover may be loosely or movably connected to the carrier, e.g., via plug connections, or pivotable via a hinge.

### Electrically Conductive Pipette Tip Holders

The pipette tips are essentially horizontally (i.e. in the plane of the upper and/or lower surfaces) immovably arranged in a tray according to the invention and they are in contact with an electrically conductive element that extends to the openings of the tray.

The pipette tip holders according to the invention have the advantage that electrostatic charging of the pipette tips contained in the pipette tip holder is prevented by dissipating the charge to a grounded object. The pipette tips contact the electrically conductive tray and are thus in electrically conductive contact with the bottom area of the carrier. Instead of dissipation via the bottom area, it would be conceivable to dissipate the charge via an external grounding contact with the tray or the carrier.

One or more components of the device may consist of electrically conductive material and/or contain one or more other materials that are not electrically conductive but do not significantly affect the conductivity of the conductive material.

The electrically conductive material may comprise any type of known electrically conductive material, such as electrically conductive metal, which may be arranged at the respective component of the holding device, e.g., in the form of metal coatings, films attached to the component, or within a matrix, e.g., in the form of metal powder. Carbon is another suitable electrically conductive material that may be embedded in a carrier material to provide electric conductivity.

It is preferred that the pipette tips, or at least parts thereof, are in contact with the electrically conductive material of the tray, e.g., via the contact points or support surfaces between the pipette tip and the tray. The tray is electrically conductive in such a way and to such an extent that the electrostatic charge may be dissipated from the pipette tips.

A method for discharging static electricity from pipette tips into a device for holding pipette tips comprises the step of: providing a pipette tip holding device comprising a carrier, a tray, optionally a lid, and pipette tips, wherein the tray comprises conductive material that is in contact with the pipette tips received on the openings of the tray.

Coating methods may be used to produce electrically conductive lines, e.g., vapor deposition of metal layers, or conductive material may be incorporated in a matrix of the material forming the components of the holding device. The component with the conductive material may be molded or cast, whereby antistatic materials may be added before or during molding.

### Pipette Tips

Pipette tips with different geometries are known. The geometry of a pipette tip is adapted so that it is suitable for picking up and dispensing liquids in conjunction with a coupling device of a pipetting device or automatic pipetting machine. Pipette tips are usually available in different sizes, e.g., 10 microliters, 50 microliters, 100 microliters, 250 microliters, 1000 microliters, 2500 microliters, etc.

The outer contour and the inner contour of pipette tips are adapted for use in conjunction with or interaction with a specific pipetting device or pipetting machine. Usually the outer contour of pipette tips tapers from the upper (proximal) section to the lower (distal) section, wherein the lower distal section has a small opening. The outer and inner contour is suitable for allowing attachment to a coupling device of a pipetting device or pipetting machine.

The inner wall of the pipette tip defines a substantially tapered inner volume, whereby enlargements of the inner diameter or inwardly extending projections may also be provided in sections of the wall delimiting the inner space of the pipette tip. The taper may be continuous and/or stepped, steady and/or unsteady, either from top to bottom or in sections. It must be ensured that fluid taken up has suitable fluid flow properties. In most embodiments, a pipette tip wall comprises at least two taper angles.

The outer and inner walls have a substantially tapered, for example stepped or conical, contour. The taper angle(s) is/are approximately between 0° and 30° relative to the central longitudinal axis, e.g., 0°, 5°, 10°, 15°, 20°, 25°, 30°. In some embodiments, the contour is stepped or cylindrical. Steps or stops or grooves may also be provided.

A typical conventional pipette tip has a total length of approximately 2.5 cm to 10 cm. The distal dispensing opening typically has an inner diameter of approximately between 0.2 mm and 0.8 mm, e.g., 0.2 mm, 0.3 mm, 0.4 mm, 0.5 mm, 0.6 mm, 0.7 mm, 0.8 mm. The wall thickness in this area is approximately 0.1 mm and 0.5 mm, e.g., 0.1 mm, 0.2 mm, 0.3 mm, 0.4 mm, 0.5 mm.

In the proximal range, the inner diameter is approximately 2.5 mm to 10 mm, e.g., 2.5 mm, 5 mm, 7.5 mm, 10 mm, with a typical wall thickness in the proximal section between 0.5 mm and 1.5 mm, e.g., 0.5 mm, 0.75 mm, 1.0 mm, 1.25 mm, 1.5 mm.

The wall thickness may be constant along a section or vary continuously and/or in steps.

A proximal or distal section of a pipette tip may contain a filter, an insert, or other auxiliary material.

In an embodiment, (disposable) pipette tips comprise: a wall defining an interior space; a first, upper opening and a second, lower opening located at the upper end and lower end of the interior space, respectively; a first section adjoining the upper opening; a second section adjoining the first section; a third section adjoining the second section; a fourth section adjoining the third section; and a fifth section adjoining the fourth section and opening into the lower opening; a first transition area between the first section and the second section; a second transition area between the second section and the third section; a third transition area between the third section and the fourth section; wherein the sections and the transition areas may have an inner contour or inner geometry or a configuration as described below in the description of the invention.

The terms “top”, “above”, “upper” refer to an area of the wall or interior of the pipette tip closer to the first, upper opening, into which a retaining/sealing mandrel of the pipetting machine may penetrate as intended in order to hold and seal the pipette tip. The terms “bottom”, “below”, “lower” refer to an area of the wall or interior of the pipette tip closer to the second, lower opening, through which the pipetted fluid is intended to be taken up or dispensed during operation. The upper opening is usually larger than the lower opening.

The direction “from top to bottom” means the axial direction from the upper opening to the lower opening. “Axial” is a direction perpendicular to a plane defined by the upper and/or lower edge of the pipette tip. ‘Radial’ means a direction parallel to the plane defined by the upper and/or lower edge of the pipette tip, i.e., perpendicular to “axial”. A taper or cross-sectional reduction from top to bottom means that the cross-section at a position closer to the first opening is larger than the cross-section at a position closer to the second opening. A widening or cross-sectional enlargement occurs when the cross-section at a position closer to the first opening is smaller than the cross-section at a position closer to the second opening. This applies to both the sections of the pipette tip and the transition areas.

Sections of the wall or interior of the pipette tip have an axial and, optionally, a radial extension. Transition areas of the wall or interior of the pipette tip may have an axial extension and/or a radial extension. However, they may also be designed without axial/radial extension as a continuous transition, e.g., as an edge.

An undercut exists in the case of a widening or cross-sectional enlargement (when viewing the interior through the upper opening in the direction of the lower opening), as described above. An undercut may be a continuous transition with or without axial extension. A pipette tip according to the invention comprises: a wall delimiting an interior space; a first, upper opening and a second, lower opening, which are arranged at the upper end and the lower end of the interior space, respectively; a first section, which is connected to the upper opening; a second section, which is connected to the first section; a third section, which is connected to the second section; a fourth section, which is connected to the third section; and a fifth section adjoining the fourth section and opening into the lower opening; a first transition area between the first section and the second section; a second transition area between the second section and the third section; a third transition area between the third section and the fourth section); wherein the diameter of the upper opening is greater than the diameter of the lower opening; wherein the interior space has at least sectionally cylindrical and/or tapered sections and/or transition areas from top to bottom.

Optionally, the interior may have at least one section and/or transition area that widens from top to bottom, so that an undercut is formed.

Pipette tips may be provided individually or as several pipette tips connected, e.g., in a strip (1×6 tips) or in an array (e.g., 2×3 tips).

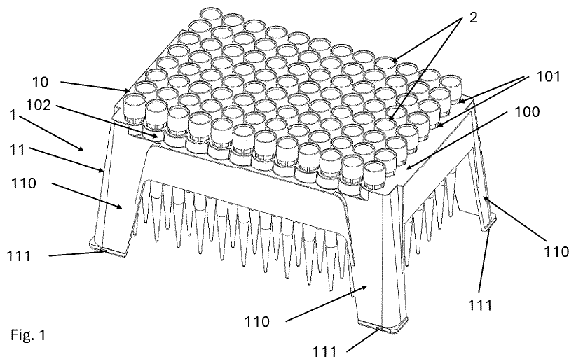

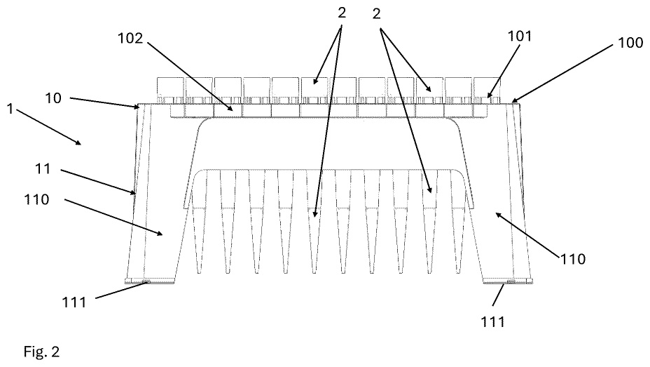

FIGS. 1 and 2 show a first embodiment of the invention. A device 1 according to the invention for holding pipette tips 2 has a type of tray 10 (placement or holding plate) with a holding area 100 and openings or cutouts 101 formed in the holding area 100, which are adapted to the shape of the pipette tips 2 in order to hold them in a specific position. The cutouts 101 may, for example, be bounded by sleeves 102.

The pipette tips 2 (as described above) may rest on the edge of the corresponding opening 101 or the corresponding sleeve 102. The pipette tips 2 may, for example, be lifted out of the openings 101 or inserted into the openings 101 by an automated liquid handling system (not shown).

In the lower region, the device 1 has a carrier 11 comprising four legs 110 extending downward from the tray 10. A base surface 111 is formed on the underside of each of the legs 110, by means of which the device 1 stands, for example, on the floor of a liquid handling system. In this embodiment, tray 10 and carrier 11 are designed as a single piece or one-piece.

The pipette tips 2 may be made of electrically conductive or non-conductive material. The materials, in particular plastic materials, may be more or less transparent or more or less opaque.

However, the pipette tips 2 arranged in tray 10 may become electrostatically charged at certain stages of their service life, for example during manufacture, transport, or during use in the liquid handling system, which leads to undesirable effects.

To counteract this problem, device 1 (i.e., tray 10 and carrier 11) is made of electrically conductive plastic in order to establish an electrical connection from the pipette tips 2 to the base 111 of device 1, whereby electrostatic charge may be dissipated from the pipette tips to the bottom of the liquid handling system. In this way, interference during the intake/discharge of liquids into/from the interior of the pipette tips 2, during measurements, during fluid transfer, etc., is prevented.

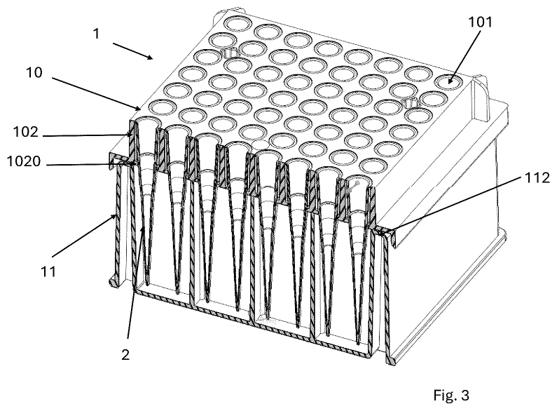

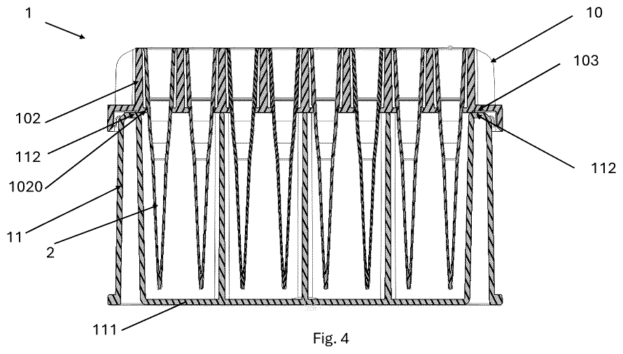

FIGS. 3 and 4 show a second embodiment of the device 1 according to the invention in a perspective view with a section through a vertical plane and a side view in a cross-section, respectively.

Corresponding components are designated with the same reference numerals as in the first embodiment. As described in the previous embodiment, a tray 10 is fixedly connected or removably mounted on a carrier 11, in particular on one or more shoulders 112 of the carrier 11.

Pipette tips 2 are arranged in sleeves 102 of the tray 10. The pipette tips 2 have an outer contour such that they may rest on inner projections 1020 of the sleeves 102.

As described before, the device 1 (i.e., in particular tray 10 and carrier 11) of this embodiment is made of electrically conductive plastic in order to establish an electrical connection from the pipette tips 2 to the base 111 of the device 1, so that electrostatic charge may be dissipated from the pipette tips 2 to the bottom of the liquid handling system. The electrostatic charge may flow off in particular via a support surface 103 of the tray 10 and the shoulder(s) 112 of the carrier 11.

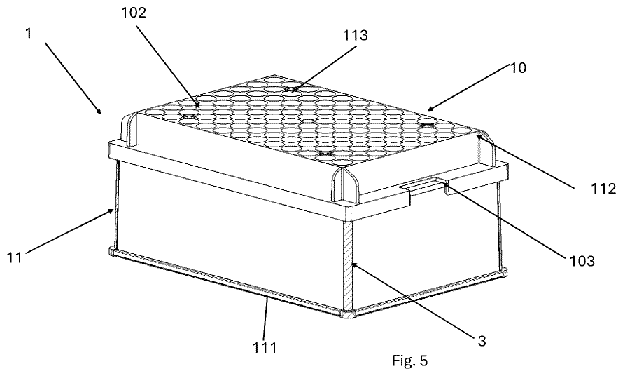

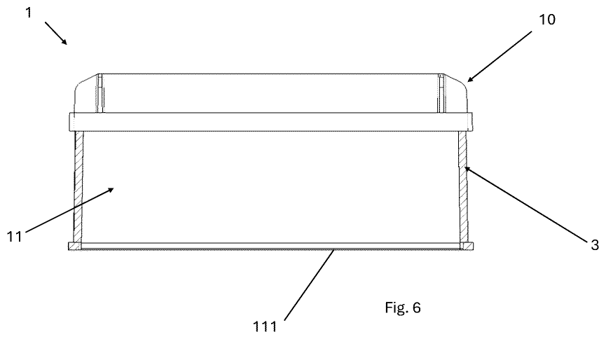

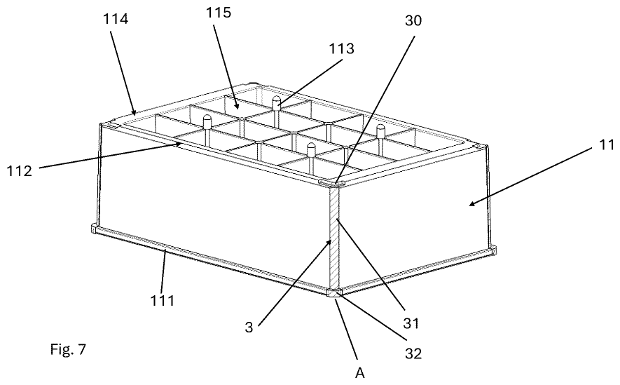

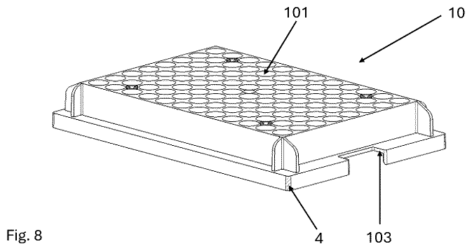

FIGS. 5 to 8 show a third embodiment of the device 1 according to the invention. FIGS. 5 and 6 show the entire device 1, while FIGS. 7 and 8 show the carrier 11 and the tray 10, respectively.

The tray 10 is made of electrically conductive plastic in order to be able to conduct electrostatic charge from pipette tips 2 inserted in the tray to the carrier 11.

In this embodiment, the carrier 11 may, alternatively, be made of non-conductive plastic. Instead, conductor tracks 3 are arranged on the four vertical edges (shaded). The conductor tracks 3 may be clipped into the component or injected or in-molded using a 2K (2-component) injection molding process. The conductor tracks 3 are made of electrically conductive material, e.g., electrically conductive plastic/resin.

As may be seen in particular in FIG. 7, each of the conductor tracks 3 consists of an upper first contact area 30 for establishing electrical contact with the tray 10, and a connecting area 31 between the first contact area 30 and a second lower contact area 32 for establishing electrical contact with the support surface A of a pipetting device (not shown).

In addition, the carrier 11 has positioning pins 113 which, when assembled, engage in corresponding counter bearings (e.g., openings) of the tray 10. Furthermore, the carrier 11 has a frame 114 which frames a window 115 into which the tray 10 may be inserted.

In order to establish improved electrical contact between the tray 10 and the carrier 11 or the conductor track 3, conductive areas 4 (see FIG. 8) may be formed or arranged in the corners of the angled support area 103 of the tray. When assembled, they are connected to the first contact areas 30 of the carrier 11.

Inserted pipette tips 2 extend through the openings 101 of the tray 10 and the window 115 of the carrier 11 into an interior space of the carrier 11.

1. A device for holding pipette tips, comprising:
at least one tray having at least one placement or holding area with a plurality of openings for inserting the pipette tips, wherein the tray comprises electrically conductive material for dissipating electrostatic charge from the pipette tips.

2. The device for holding pipette tips according to claim 1, comprising:
a carrier (rack) for supporting the tray, wherein the carrier has a frame with a window arranged in the upper region of the frame for inserting the tray, and a standing surface arranged in the lower region of the frame.

3. The device for holding pipette tips according to claim 1, comprising:
a carrier (rack) for supporting the tray, wherein the carrier and the tray are formed as a single piece as a combined carrier/tray component, which has a standing surface arranged in the lower region of the component.

4. The device for holding pipette tips according to claim 2, wherein the carrier has electrically conductive material for dissipating electrostatic charge from the tray to the standing surface.

5. The device for holding pipette tips according to claim 3, wherein the carrier has electrically conductive material for dissipating electrostatic charge from the tray to the standing surface.

6. The device for holding pipette tips according to claim 2, wherein at least one of the tray and the carrier, and the combined carrier/tray component, respectively, is made of electrically conductive material.

7. The device for holding pipette tips according to claim 3, wherein at least one of the tray and the carrier, and the combined carrier/tray component, respectively, is made of electrically conductive material.

8. The device for holding pipette tips according to claim 2, wherein at least one of the tray and the carrier, and the combined carrier/tray component, respectively, comprises conductive plastic.

9. The device for holding pipette tips according to claim 3, wherein at least one of the tray and the carrier, and the combined carrier/tray component, respectively, comprises conductive plastic.

10. The device for holding pipette tips according to claim 2, wherein at least one of the tray and the carrier, and the combined carrier/tray component, respectively, has at least one conductor track which is designed to establish an electrical connection between the openings of the tray and the standing surface.

11. The device for holding pipette tips according to claim 3, wherein at least one of the tray and the carrier, and the combined carrier/tray component, respectively, has at least one conductor track which is designed to establish an electrical connection between the openings of the tray and the standing surface.

12. The device for holding pipette tips according to claim 10, wherein the conductor track is made of electrically conductive material.

13. The device for holding pipette tips according to claim 11, wherein the conductor track is made of electrically conductive material.

14. The device for holding pipette tips according to claim 10, wherein the conductor track is made of electrically conductive plastic/resin.

15. The device for holding pipette tips according to claim 11, wherein the conductor track is made of electrically conductive plastic/resin.

16. The device for holding pipette tips according to claim 10, wherein the conductor track has at least one of contact areas and connection areas.

17. The device for holding pipette tips according to claim 11, wherein the conductor track has at least one of contact areas and connection areas.

18. The device for holding pipette tips according to claim 10, wherein the conductor track is integrated in the electrically conductive material of at least one of the tray and the carrier, and the combined carrier/tray component, respectively.

19. The device for holding pipette tips according to claim 10, wherein the conductor track is arranged as a coating on at least one of the tray and the carrier, and the combined carrier/tray component, respectively.

20. The device for holding pipette tips according to claim 11, wherein the conductor track is integrated in the electrically conductive material of at least one of the tray and the carrier, and the combined carrier/tray component, respectively.

21. The device for holding pipette tips according to claim 11, wherein the conductor track is arranged as a coating on at least one of the tray and the carrier, and the combined carrier/tray component, respectively.
